(19) United States
(12) Patent Application Publication
(10) Pub. No.: US 2021/0406997 A1
(43) Pub. Date: Dec. 30, 2021

(54) Personal Profitability

(71) Applicant: Grace Park, Amagansett, NY (US)

(72) Inventor: Grace Park, Amagansett, NY (US)

(21) Appl. No.: 16/199,518

(22) Filed: Nov. 26, 2018

(51) Int. Cl. G06Q 40/02; G06Q 40/00; G06Q 10/10

(52) U.S. Cl. CPC G06Q 40/02; G06Q 10/10; G06Q 40/12

(57) ABSTRACT

Personal Profitability is a methodology, representing a set of integrated processes and concepts which enable an individual to achieve financial independence, through three key analyses: 1. Personal Monthly Cash How, 2. Personal Balance Sheet, and 3) Multi-Year Forecast. The forecast for these analyses are based on 4 key concepts: 1) Risks, 2) Opportunities, 3) Provision, and 4) Tasks. What makes this invention new is that an individual's multiple financial elements are connected in an end to end set of inter-related analyses, which when used together, show an individual their current state and how to forecast towards financial independence. By using Personal Profitability all actions and decisions impacting various elements of one's financial situation would be apparent through these analyses. Personal Profitability provides an integrated methodology which ties all aspects of financial management together.

### BACKGROUND

Financial independence is a subject on many people's minds: whether one is a millennial or a baby boomer, the ability to ensure that one has enough money for one's lifetime is a significant source of stress for most people. While people have tried to use budgeting took, financial advisors, and self-directed investing, there is no one holistic framework which ties together the key elements of one's financial health: expenses and income, assets and liabilities, from the perspective of now and future years as a dashboard for future actions. Because of the fragmentation; many individuals tend to operate blindly, without context (e.g. how much money do they need in retirement) with disparate pieces of data (banking and brokerage statements), The services provided to individuals are either on-line with little personalized contact, or personalized by individuals who may be compensated towards selling more expensive products versus those with same performance, but less lucrative. By executing a methodology such as Personal Profitability, an individual is able to understand their current financial situation, as well as identify what actions they may need to take in the future. They will have the context and metrics exist in order to create transparency on how financial actions help or hinder their Personal Profitability.

### SUMMARY

By providing a methodology, processes, and framework, an individual would be able to able to understand and control their “personal profitability” status in an integrated way. By using the Personal Balance Sheet, the Monthly Cashflow, and the Multi-Year Forecast view, the methodology integrates the important elements of an individual's financial needs together over time to present how the individual is performing based on their future goals through reporting actuals and forecasting future outcomes. It is connected to and ties together what has previously been fragmented elements of an individual's financial plan: assets, liabilities, and cash flow.

The objective and benefits of the system would be to allow the individual to make the necessary adjustments in their spending and investing decisions based on their goals, their income, and their expenses over a multiyear period as events based on their actuals and forecast. The Personal Profitability analyses allow the individual to view and monitor the impacts of earning, spending, and saving on one's holistic financial health now and in the future by using the Personal Monthly Cash How, Personal Balance sheet, and Multi-Year forecast. Maintaining the integrity of the analyses requires active forecasting based on the concepts of Risks, Opportunities, Provision and Task.

### BRIEF DESCRIPTION

The individual would create the three analyses of Personal Monthly Cash How, Personal Balance Sheet, and the Multi-Year forecast either manually or using Excel. Once the analyses have been created, the individual would then update the analyses as actual results come in. The individual would also forecast future results as it relates to the line items tracked in each of the three analyses through identification of Risks, Opportunities, Provision and Task. By continuously updating the analyses with these 4 categories, the individual is able to improve the accuracy of his/her forecast. These spreadsheets used together allow an individual to track and map their financial health. The Multi-Year Forecast projects how today's actions and situation impact the individual's future cash flows. The Personal Monthly Cashflow analysis helps the individual understand their current spend, compared to their after-tax income. The Personal Balance Sheet provides a monthly view of their net worth and the impact of debt on their net worth (and costs of carrying the debt in the Monthly Cashflow analysis), The ability to forecast accurately the status of one's financial situation increases awareness of day to day actions and acts as an early predictor of potential issues, allowing the individual to take pre-emptive action and change behavior. The analyses serve as a dashboard to the individual, allowing them to make necessary adjustments based on the data shown.

### DETAILED DESCRIPTION

The Personal Profitability invention is a framework, methodology and set of integrated analyses which track the end to end financial health of an individual seeking financial independence. The methodology is made up of three key analyses (Personal Balance Sheet, Monthly Cashflow, and Mufti-Year Forecast}, and supported by 4 forecasting concepts (Risks, Opportunities, Provision, and Task) which track and enable the end to end journey of an individual seeking financial independence. By engaging and enabling the individual to understand their cash flow, balance sheet, and future goals using these spreadsheets/analyses, the individual is able to make decisions affecting their future financial outcomes. By using the concepts of Risk, Opportunities, Provision and Task, the individual can improve the accuracy of their financial forecasts and gain confidence in in the accuracy of their numbers.

The Monthly Cash Flow analyses consists of a listing of income and expense line items, as well as after tax income to develop a true monthly cash flow view. This analysis will show every month, by category, the actual numbers well as the forecasted numbers for every month for a full calendar year view. The analysis allows the individual to update their analysis based on actuals, as well as change forecasts for future months. Income line items are categories such as salary, interest income, and investment income (dividends). Fixed expense line items are categories such as rent, taxes, and insurance premiums. Variable expense line items are categories such as food, entertainment, and gifts. The monthly cash flow subtotals include: 1) expenses (fixed and variable), income (pre-tax and after-tax) down the left axis, showing a net income number by month (across the y axis), and ending with a full year total (actuals plus forecast monthly net income numbers).

The Personal Balance Sheet analysis consists of a listing of all assets and liabilities owned by the individual. This analysis will show every month for the calendar year, what the individual's net worth based on the month-end valuations of all assets and liabilities, and will be updated based on the most recent data such as balances in banking accounts, outstanding loans (credit cards, school, mortgages), etc. The Personal Balance sheet is maintained and updated (actuals and forecasts) on a monthly bask, with all asset and liability categories listed down the left axis, with every month on the y axis, totaling to a year end number based on actuals for the months past and forecasts for the future months.

The Multi-Year forecast shows all expenses, revenues, and after-tax revenues categories by year, across the lifetime of the individual. It has the same line-items and categories as the Monthly Cash flow, except the time frame is multi-year, through the anticipated lifetime of the individual. It allows the individual to forecast for future changes such as expense decreases such as Medicare, or income increases such as Social Security which will happen in later years. The Mufti-Year view will provide the individual a yearly view of expected expenses, after tax revenues, and most importantly, any shortfalls through the net income numbers which need attention.

All three analyses will depend on accurate actuals as well as accurate forecasting. Forecasting is accomplished through the use of 4 key concepts: risks, opportunities, provision and task. The ability to anticipate risks and opportunities will be key to maintaining accurate forecasts for the Monthly Cash How, the Personal Balance Sheet, and the Multi-Year forecast. Provision and Tasks represent the individual the ability to adjust for real life, without disrupting the integrity of the financial forecast.

1. A methodology called the Personal Monthly Cash Flow which consists of a listing of the major categories which make up one's expenses (fixed and variable), income, and after-tax income, summed up with a net income number total (after-tax income minus total expenses) on a monthly basis.

2. A methodology according to claim 1, wherein the actual numbers are recorded for past months, and forecast numbers are “penciled in” for future months for each line item, totalling a full year forecast for the major line item categories listed under expenses, income, and after-tax income.

3. A methodology according to claim 1, wherein fixed expenses are those expense line items which occur every month automatically such as mortgages, rent, utilities, phone bills, car payments, health insurance, and insurance premiums.

4. A methodology according to claim 1, wherein variable expenses represent those expenses which are in the control of the individual and can usually be tracked by payment method such as cash or credit/debit cards within specific categories such as food, clothing and entertainment in the monthly bank statements.

5. A methodology according to claim 1, wherein together, the fixed and variable expenses represent an individual's total expenses by month for the full year (actuals and forecast).

6. A methodology according to claim 1, wherein the total income is made up of line items such as salary, dividends, and interest income where both actuals and forecasts are recorded by month by line-item category.

7. A methodology according to claim 1, wherein after-tax income is calculated, by applying a tax rate on the pre-tax income to calculate an after-tax income number, which is included as a separate row as after-tax income depending on the tax treatment of the asset.

8. A methodology according to claim 1, wherein the net income number is the difference between the total expenses (fixed plus variable) and the after-tax income number, calculated for both actual and forecasted months and maintained for the full year.

9. A methodology called the Personal Balance sheet records all assets and liabilities, resulting in a net total worth, which is updated every month to show the actual net worth number for the month.

10. A methodology according to claim 9, wherein under Assets, the categories include line items such as Cash and cash equivalents, Investment accounts, and real estate.

11. Under Investments, according to claim 10, would include items such as brokerage accounts, 401ks, and IRA accounts.

12. A methodology according to claim 7, wherein under liabilities, line items would include the current total outstanding value for all loans and debt obligations such as student loans, mortgages, credit card debt, car loans, etc. listed separately.

13. A methodology according to claim 9, wherein the net worth number is calculated as total assets minus total liabilities and represent the total net worth of the individual on a monthly basis for the full calendar year, actuals and forecast.

14. A methodology called the Multi-Year Forecast according to claim 1, wherein the analysis represents the same Monthly Cash How line item categories but by on an annual basis, in order to provide a mufti-year view of net income for every year until death.

15. A methodology according to claim 14, wherein the same line item categories, calculations, and actuals for the Monthly Cash How analysis would tie back to the matching year in the mufti-year forecast.

16. A methodology according to claim 14, wherein the actual numbers are recorded for past months, and a forecast number is “penciled in” for future months for each line item, totalling a full year forecast for the major line item categories listed under expenses, income, and after-tax income for every year until death.

17. A methodology according to claim 9, wherein the Personal Balance sheet net worth number ties back to the Mufti-Year forecast in that assets in the Personal Balance Sheet may be available to close any financial gaps in future years through sale/liquidation.

18. A methodology wherein the Mufti-Year Forecast would include assumptions for known changes in the forecast such as retirement (salary would cease), Social Security, 401k, pensions, and Required Minimum Distribution changes which would occur later in specific years.

19. A methodology according to claims 1, 9, and 14, wherein the management of Risks, Opportunities, Provision and Tasks represent the 4 categories of possible events which would change the forecasts of the Personal Balance sheet, Monthly Cash How, or Mufti-Year Forecast.

20. A methodology according to claims 1, 9, and 14, wherein the Risks represent events likely to happen which negatively affect and require adjusting one's forecast of the Personal Balance Sheet, Monthly Cash How, and Multi Year forecast, which allow the individual to incorporate these risks in his or her forecast.

21. A methodology according to claims 1, 9, and 14, wherein the Opportunities are events likely to happen which positively affect one's forecast numbers of the Personal Balance Sheet, Monthly Cash How, and Mufti-Year forecast, and are often related to savings or increases in income such as a bonus or inheritance.

22. A methodology according to claim 21, wherein Opportunities would be earmarked in the Personal Balance Sheet, Monthly Cash How, and Multi-Year Forecast.

23. A methodology according to claims 1, 9, 14 wherein the Tasks are when an individual creates an additional goal above and beyond what is documented in the Personal Balance Sheet, Monthly Cash How, and Multi-Year forecast such as a desire to pay for a child's college tuition.

24. A methodology, according to claim 23, wherein Task items would be earmarked in the Personal Balance Sheet, Monthly Cash How, and Mufti-Year Forecast.

25. A methodology according to claims 1, 9, 14, wherein the Provision items represent assets which have not been tagged with a purpose yet but may be used for large expenses such as vacation without disrupting the documented and ongoing plan of the Personal Balance Sheet, Monthly Cash How, and Multie-Year forecast.

26. A methodology according to claim 25, wherein provision items would be earmarked in the Personal Balance Sheet, Monthly Cash How, and Multi-Year Forecast.

27. A methodology according to claims 1, 9, 14 wherein once the above framework and analyses are completed with actual and forecast numbers, the individual can plan how to cover current and future net income or net worth gaps through changes in spending, saving, and investing as part of their overall strategy with the ability to monitor the changes in the actuals and forecasted numbers of the three analyses.
